(19) United States
(12) Patent Application Publication
(10) Pub. No.: US 2004/0192255 A1
(43) Pub. Date: Sep. 30, 2004

(54) Portable radio terminal and method of setting indicatable direction of direction indicator key

(75) Inventor: Satoshi Nakamura, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION

(21) Appl. No.: 10/806,153

(22) Filed: Mar. 23, 2004

(30) Foreign Application Priority Data
Mar. 26, 2003 (JP) 85319/2003

(51) Int. Cl. H01H 15/24; H04M 1/66; H04M 3/16; H04M 1/68

(52) U.S. Cl. 455/411

(57) ABSTRACT

A direction indicator key 19 outputs directional indication indicating one direction out of predetermined plural directions and a controller 6 validates or invalidates the directional indication output by the direction indicator key 19.

### BACKGROUND OF THE INVENTION

1. Field of the Invention

The present invention relates to a portable radio terminal, particularly relates to a portable radio terminal provided with a switching function of indicatable directions of a direction indicator key.

2. Description of the Related Prior Art

For a conventional type direction indicator key, for example, there is a joy switch 30 shown in FIG. 9 and disclosed in Japanese published unexamined patent application No. Sho59-196519.

The joy switch 30 is provided with a polygonal (octagonal) switch plate 31, the outside periphery of which is polygonal, and plural direction switches 32 arranged close to each polygonal side of the switch plate 31.

The center of the switch plate 31 is supported so that the switch plate 31 can be rocked.

The plural direction switches 32 are arranged on four sides of the polygonal switch plate 31 having the other sides without a direction switch between adjacent direction switches.

In the joy switch 30, when one side of the polygonal switch plate 31 is pressed, one or two direction switches 32 is/are closed by pressure applied to the side.

At the switch plate 31, when the side on which the direction switch 32 is arranged is pressed, only the arranged direction switch 32 is closed or actuated. Then a predetermined direction corresponding to the pressed direction switch 32 is selected and indicated.

When the side with no direction switch 32 is pressed, two direction switches 32 arranged on both adjacent sides of the side are actuated. Then, an intermediate direction (diagonal direction) between two directions corresponding to the actuated two direction switches 32 is selected and indicated.

Hereby, the joy switch 30 can indicate eight directions by operating four direction switches 32 and by pressing the four sides with no switch 32. The joy switch 30 is always performed as an eight direction switch. It cannot be switched so that only four directions can be indicated and eight directions can be indicated.

In the meantime, when a user of a portable radio terminal such as a mobile telephone and PHS selects a desired item on a menu screen, for example, by moving a cursor in the direction operated by a direction indicator key, the number of directions which can be easily operated is different every menu screen. If plural selectable items on the menu screen are arranged two-dimensionally, the eight direction switch for indicating the eight directions including diagonal directions is convenient because the user can more easily operate. If selectable items on the menu screen are arranged one-dimensionally longitudinally or laterally, four direction switch is convenient. In this case, the eight direction switch that can indicate the diagonal direction is sometimes inconvenient for the user.

That is, even if only four directions are necessary, the user operating the eight direction switch may indicate a diagonal direction by mistake. At this time, even if the user indicates the diagonal direction on the direction indicator key many times, the position of an active item showing a currently selected item on the menu screen is not shifted. Therefore, the user cannot select the desired item.

### SUMMARY OF THE INVENTION

A portable radio terminal according to the present invention is provided with a direction indicator key that outputs directional indication showing one direction out of predetermined plural directions and a controller that validates or invalidates the directional indication output by the direction indicator key.

A first method of setting an indicatable direction of the direction indicator key according to the present invention includes a first step for specifying a direction in which directional indication output by the direction indicator key is validated and a second step for setting the valid direction specified in the first step.

A second method of setting an indicatable direction of the direction indicator key according to the present invention sets a valid direction according to the following switched screen and showing a direction in which directional indication output by the direction indicator key is judged valid when the currently displayed screen is switched to another screen.

### BRIEF DESCRIPTION OF THE DRAWINGS

The objects, features and advantages of the present invention will become apparent from the following detailed description when taken with the accompanying drawings in which:

FIG. 1 is a block diagram showing one embodiment of a portable radio terminal according to the present invention;.

FIG. 2 shows one example of the section of a direction indicator key used in the portable radio terminal according to the present invention;

FIG. 3 shows one example of the arrangement of the direction indicator key provided to the portable radio terminal according to the present invention;

FIG. 4 shows valid directions when eight directions of the direction indicator key are validated;

FIG. 5 shows valid directions when four directions of the direction indicator key are validated;

FIG. 6 is a flowchart showing one example of operation for changing indicatable directions of the direction indicator key of the portable radio terminal according to the present invention;

FIGS. 7A and 7B show examples of a menu screen;

FIG. 8 shows one example when a part corresponding to a direction indicated by directional indication in a figure showing valid directions is changed and displayed; and

FIG. 9 shows one example of a conventional type direction indicator key.

### DETAILED DESCRIPTION OF THE PREFERRED EMBODIMENTS

Next, referring to the drawings, a preferred embodiment of the present invention will be described.

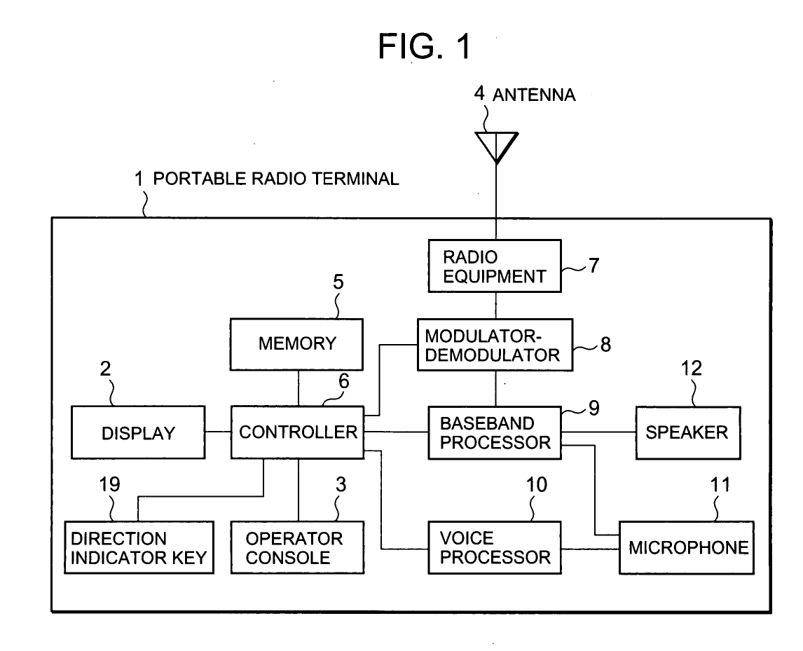

This embodiment shown in FIG. 1 relates to a mobile telephone as an example of a portable radio terminal 1 and the portable radio terminal 1 is mainly composed of a display 2, an operator console 3, a controller 6 and a direction indicator key 19.

The portable radio terminal 1 is further provided with an antenna 4, a memory 5, radio equipment 7, a modulator-demodulator 8, a baseband processor 9, a voice processor 10, a microphone 11 and a speaker 12.

The radio equipment 7 filters a signal received from the antenna 4 and sends it to the modulator-demodulator 8. It also amplifies a sending signal and outputs it to the antenna 4.

The modulator-demodulator 8 performs the processing of the radio frequency of the received signal from the radio equipment 7, demodulates and converts it to a receive baseband signal. The modulator-demodulator 8 also modulates a baseband signal for sending, converts it to a sending signal and sends it to the radio equipment 7.

The baseband processor 9 decodes voice data in the receive baseband signal from the modulator-demodulator 8, generates an aural signal, outputs it to the speaker 12 and reproduces voice.

Data such as an image data and a mail data except voice data in the receive baseband signal from the modulator-demodulator 8 is read by the controller 6 and is output to the display 2 and the memory 5.

The baseband processor 9 encodes voice input from the microphone 11, generates a baseband signal for sending and sends it to the modulator-demodulator 8.

The voice processor 10 processes voice input from the microphone 11.

Transmit data except voice data is supplied from the controller 6 and is output to the modulator-demodulator 8 via the baseband processor 9.

The controller 6 controls the whole portable radio terminal 1 that executes a series of transmitting/receiving processing described above.

The memory 5 stores system programs and data required for the operation and the control of the portable radio terminal 1.

The direction indicator key 19 outputs directional indication indicating one direction out of predetermined plural directions (at least four directions) according to the operation of a user.

The operator console 3 outputs the specification of a valid direction specifying whether the directional indication is validated based upon a direction indicated by the directional indication according to the operation of the user or not.

The controller 6 validates or invalidates the directional indication output by the direction indicator key 19 according to the specification of the valid direction output by the operator console 3.

The display 2 displays plural areas for displaying items showing the contents of operation and the contents of processing under the control of the controller 6. It displays an area corresponding to a currently selected item out of the plural areas as an active area. For example, it displays the active area by enclosing the active area with a thick frame or it does reversing display of the active area.

The controller 6 shifts the position of the current active display on the display 2 to a direction indicated by the directional indication when the directional indication is validated according to the specification of the valid direction.

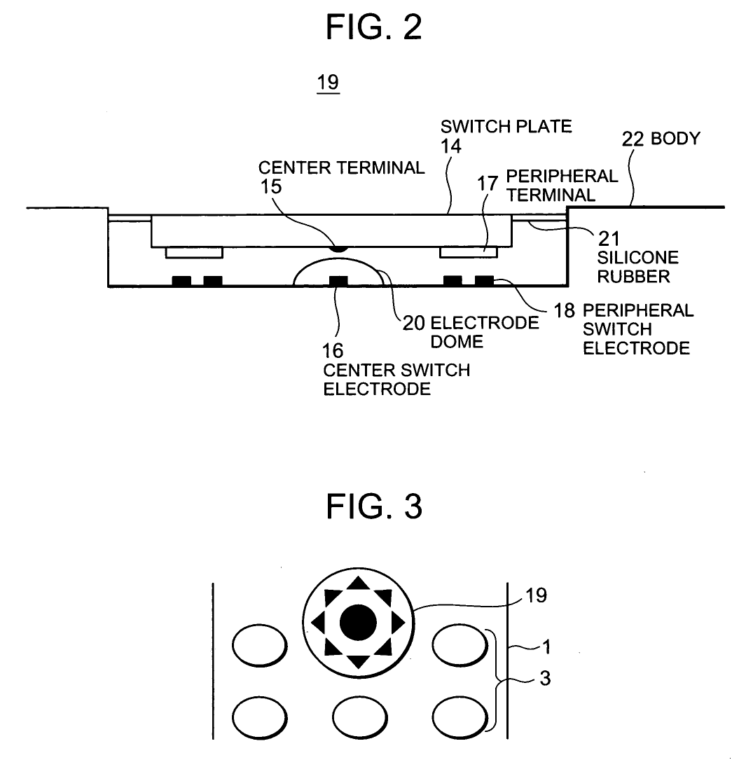

Next, referring to FIGS. 2 to 8, the operation of the portable radio terminal equivalent to this preferred embodiment will be described in detail.

FIG. 2 shows one example of the section of the direction indicator key used in the portable radio terminal according to the present invention.

The direction indicator key 19 is set in the body 22 of the portable radio terminal 1.

The direction indicator key 19 is composed of a switch plate 14, a center terminal 15, a center switch electrode 16, a peripheral terminal 17, a peripheral switch electrode 18, an electrode dome 20 and silicone rubber 21.

The peripheral terminal 17 is attached to each part equivalent to eight longitudinal, lateral and diagonal directions of the periphery of the plate one by one on the back of the switch plate 14. One center terminal 15 which functions as an operation determination key is attached to the center of the plate.

Under the switch plate 14, the peripheral switch electrodes 18 and the center switch electrode 16 are arranged in each corresponding position to nine terminals attached to the back of the switch plate 14.

The peripheral terminal 17 is made of a conductive substance and a pair of two peripheral switch electrodes 18 exist under one peripheral terminal 17. When the periphery of the switch plate 14 is pressed, the peripheral terminal 17 attached to the periphery is contacted to a pair of two peripheral switch electrodes 18 under the terminal. The two peripheral switch electrodes 18 are energized via the peripheral terminal 17 by the contact. The controller 6 senses the key input by energizing and judges that input that indicates a direction corresponding to the peripheral switch electrodes 18 is provided.

The center switch electrode 16 is covered with the electrode dome 20 made of a conductive substance such as metal. When the center of the switch plate 14 is pressed, the center terminal 15 is lowered and the electrode dome 20 is made concave by the center terminal 15. The electrode dome 20 and the center switch electrode 16 are touched and energized. The controller 6 senses the key input by energizing and judges that input showing the determination of operation is provided.

The switch plate 14 is attached to the body 22 with the center terminal 15 in the center by silicone rubber 21 so that the switch plate is held horizontal with the body 22. Besides, the switch plate 14 is restored to an original horizontal position when pressing is released after the switch plate 14 is pressed.

When the center of the switch plate 14 is pressed, the whole switch plate 14 is lowered, and the electrode dome 20 and the center switch electrode 16 are energized before the peripheral switch electrodes 18 are energized.

When the peripheral part of the switch plate 14 is pressed, the plate is inclined with the center (the center terminal 15) of the plate as the central axis of inclination. The peripheral terminal 17 and the peripheral switch electrode 18 are touched.

The switch plate 14 is inclined in a pressed direction with the center terminal 15 as the central axis of inclination even if the position corresponding to any direction at 360 degrees of the peripheral part of the plate is pressed.

In this case, the key input is sensed by energizing. However, if contact between the terminal and the electrode is sensed such as magnetism is sensed by a magnetometric sensor and the key input is sensed, any equipment may be also used.

FIG. 3 shows one example of the arrangement of the direction indicator key provided to the portable radio terminal according to the present invention. The direction indicator key 19 is schematically represented by a black circle located in the center and plural black triangles located in the peripheral part. The black circle corresponds to the position of the center terminal 15 for determining operation. The black triangle corresponds to the position of the peripheral terminal 17 for indicating a direction. The controller 6 senses the key input when the black circle and the black triangle are pressed.

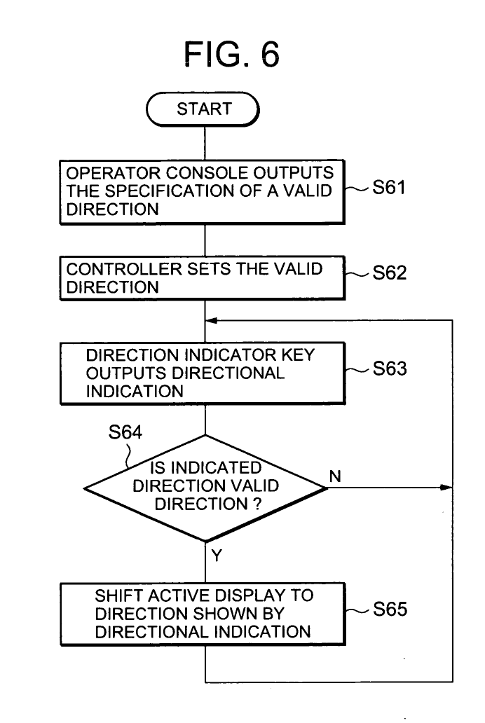

Referring to a flowchart shown in FIG. 6, the operation using the direction indicator key 19 of the portable radio terminal 1 will be described below.

In a step 61, the operator console 3 outputs the specification of a valid direction specifying whether directional indication indicated by the direction indicator key 19 according to the operation of the user is validated or not.

In the specification of the valid direction, a direction in which the indication of the direction indicator key 19 is validated is specified.

That is, the operator console 3 outputs the specification of a valid direction specifying whether directional indication is validated or not according to the operation of the user collectively every predetermined directional group. As for the directional group, for example, there are two types of a group showing four basic directions showing four longitudinal and lateral directions and a group showing eight directions acquired by adding four extended directions showing four diagonal directions to the four basic directions. The specification of whether directional indication is valid or not is made based upon a direction indicated by the directional indication. The four basic directions denote four longitudinal and lateral directions. The four extended directions denote four diagonal directions.

In this example, two types of directional groups of the group including the four basic directions and the group including the eight directions are provided, however, the eight directions are divided into plural groups and plural types may be also provided. Besides, two types of directional groups of the group including four basic directions and the group including four extended directions may be also provided. As described above, directional groups may be suitably set.

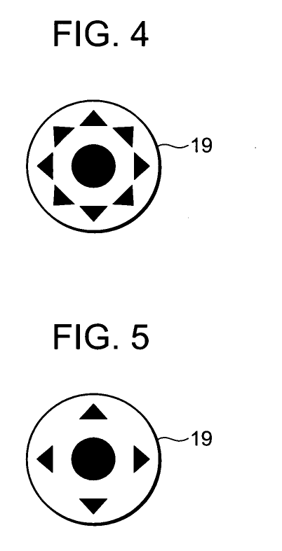

In a step 62, the controller 6 sets the valid direction specified by the specification of the valid direction. When the specification of the valid direction specifies that only four basic directions are validated, four directions (black triangles) shown in FIG. 5 are valid. When the specification of the valid direction specifies that eight directions acquired by adding extended four directions to the four basic directions are validated, eight directions (black triangles) shown in FIG. 4 are valid.

The controller 6 instructs the display to display a figure showing the valid direction on a screen in case the screen requiring the use of the direction indicator key 19 is displayed on the display 2.

The screen requiring the use of the direction indicator key 19 means a screen on which plural areas for displaying items showing the contents of operation and the contents of processing are displayed and for example, means a menu screen, an address book creation screen and so on.

The figure showing the valid directions means an indicator showing all directions in which directional indication output by the direction indicator key 19 is judged valid.

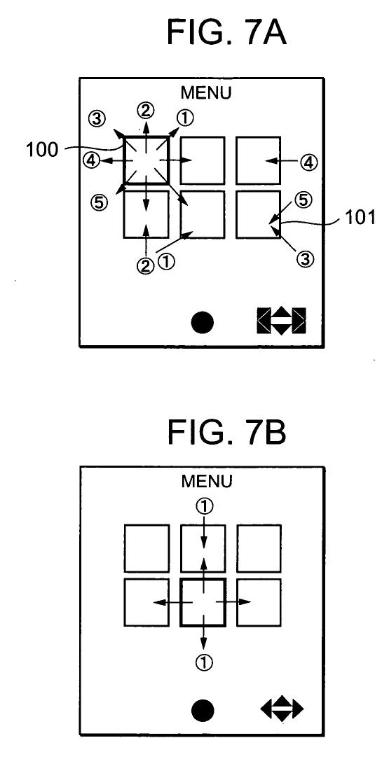

The controller 6 instructs the display 2 to display a figure showing valid directions on the right downside of the screen as shown in FIG. 7A when the set valid directions are eight directions.

The controller 6 also instructs the display 2 to display a figure showing valid directions on the right downside of the screen as shown in FIG. 7B when the set valid directions are four directions.

FIGS. 7A and 7B show each one example of the menu screen and respectively show six square areas and the figure showing valid directions. The controller 6 instructs the display 2 to display an item showing the contents of operation, the contents of processing and so on in these areas.

In a step 63, the direction indicator key 19 outputs directional indication indicating one direction out of eight longitudinal, lateral and diagonal directions according to the operation of the user.

In a step 64, the controller 6 receives the directional indication output by the direction indicator key 19 and checks whether a direction indicated by the directional indication is included in the valid directions set in the step 62 (S62) or not. When the direction is included in the valid directions, the process proceeds to a step 65 (S65). When the direction is not included in the valid directions, the process is returned to the step 63 (S63). Hereby, when one direction out of four extended directions is specified as directional indication in case the valid directions are only four basic directions for example, the controller 6 performs nothing. The controller accepts the next input of the direction indicator key 19.

In the step 65, the controller 6 shifts the position of active display currently displayed with a thick frame to a direction indicated by directional indication in case the controller 6 instructs the display 2 to display the menu screen shown in either of FIGS. 7, and the process is returned to the step 63 (S63).

That is, the controller 6 selects an item corresponding to an adjacent area in a direction indicated by directional indication of an area as a starting point currently displayed as an active area. The controller 6 instructs the display 2 to display the area corresponding to the item as an active area.

At this time, the controller 6 changes the display color and the display form of a part corresponding to a direction indicated by directional indication in the figure showing valid directions and instructs the display 2 to display it.

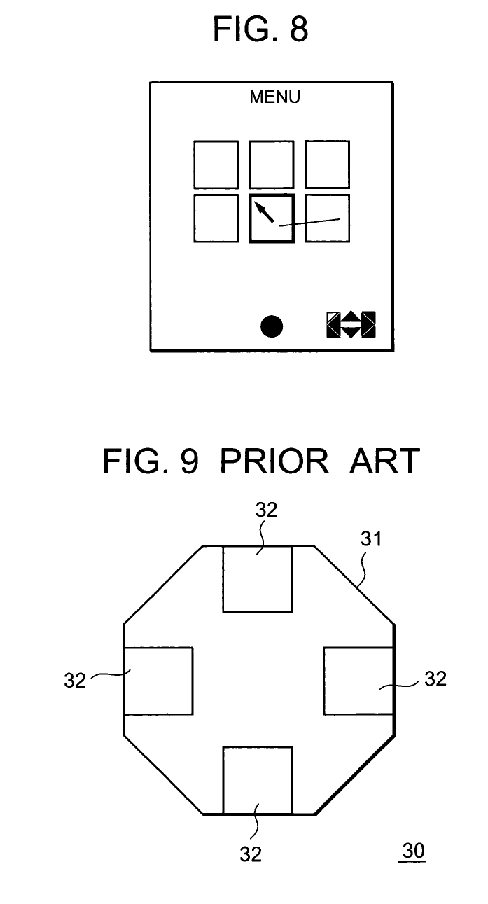

FIG. 8 shows one example when a part corresponding to a direction indicated by directional indication in the figure showing valid directions is changed and displayed. In FIG. 8, the display color of a triangle on the left upside of the figure showing valid directions is changed.

The shift of active display controlled by the controller 6 will be described using FIGS. 7A and 7B below.

In case a certain direction is indicated using the direction indicator key 19, active display is shifted to an area including an arrow having the same number as arrows (\mathring{1} to \mathring{5}) outgoing from an area 100 displayed as an active area.

In case there is no area in a direction to be indicated from the position of active display, the active display is shifted to an area in a reverse position. For example, in FIG. 7A, it is supposed that directional indication is made in a left downward direction (a direction in which the arrow \mathring{5} is outgoing) from the area 100 on the left upside displayed as an active area. At this time, as there is no area on the left side of the area 100 displayed as an active area, an area 101 (which the arrow \mathring{5} enters) on the right downside becomes an active area.

When eight directions can be indicated by the direction indicator key 19 as in the case shown in FIG. 7A, active display can be shifted to all areas by only pressing the direction indicator key 19 once.

The menu screens shown in FIGS. 7A and 7B have been described for an example according to the flowchart shown in FIG. 6, however, when the screen displayed on the display 2 is switched from a menu screen to an address book creation screen for example by the operation of the user on the operator console 3, the controller 6 may also set valid directions validated on the switched screen. At this time, valid directions according to the screen may be also determined beforehand and the controller 6 may also automatically set required directions as valid directions. Besides, the controller 6 instructs the display 2 to display a figure showing valid directions provided with a figure of all directions validated on the switched screen.

Besides, maximum eight directions can be indicated by the direction indicator key 19, however, the number of indicatable directions is not required to be limited to eight.

A valid direction is specified every directional group in the above-mentioned description, however, it is specified every direction whether the direction is validated or not and directional indication may be also determined according to individual specification whether the directional indication is valid or not.

As described above, in the portable radio terminal 1 according to the present invention, directional indication output by the direction indicator key 19 is validated or invalidated by the controller 6. Therefore, operation according to any directional indication output by the direction indicator key 19 is not required. Therefore, for example, when only conventional four directions out of directional indications output by the direction indicator key 19 are validated, diagonal directions are never indicated in case indicatable directions are only conventional four directions and operation is facilitated.

While the present invention has been described in connection with certain preferred embodiments, it is to be understood that the subject matter encompassed by the present invention is not limited to those specific embodiments. On the contrary, it is intended to include all alternatives, modifications, and equivalents as can be included within the spirit and scope of the following claims.

What is claimed is:

1. A portable radio terminal, comprising:
a direction indicator key that outputs directional indication indicating one direction out of predetermined plural directions; and
a controller that validates or invalidates the directional indication output by the direction indicator key.

2. The portable radio terminal according to claim 1, further comprising:
an operator console that outputs the specification of a valid direction specifying whether the directional indication is validated based upon a direction indicated by the directional indication or not, wherein:
the controller validates or invalidates the directional indication according to the specification of the valid direction output by the operator console.

3. The portable radio terminal according to claim 1, further comprising:
a display that displays plural areas for displaying items showing the contents of operation and the contents of processing and displays the area corresponding to a currently selected item out of the plural areas as an active area based upon an instruction from the controller, wherein:
the controller shifts the position of active display currently displayed on the display to a direction indicated by the directional indication when the directional indication is validated.

4. The portable radio terminal according to claim 1, wherein:
the predetermined plural directions are at least four directions.

5. The portable radio terminal according to claim 1, wherein:
the direction indicator key indicates one direction out of eight longitudinal, lateral and diagonal directions; and
the controller divides the eight directions into plural directional groups and validates or invalidates the directional indication collectively every directional group.

6. The portable radio terminal according to claim 5, wherein:
the plural directional groups are two types of directional groups of four basic directions showing four longitudinal and lateral directions and four extended directions showing four diagonal directions.

7. The portable radio terminal according to claim 5, further comprising:
an operator console that outputs the specification of a valid direction specifying whether the directional indication is validated based upon a direction indicated by the directional indication collectively every directional group out of the plural directional groups or not, wherein:
the controller validates or invalidates the directional indication according to the specification of the valid direction output by the operator console.

8. The portable radio terminal according to claim 1, further comprising:
a display that displays a figure of valid directions showing all directions in which the directional indication is valid.

9. The portable radio terminal according to claim 8, wherein:
the controller changes a part corresponding to a direction indicated by the directional indication in the figure of valid directions and instructs the display to display the changed figure when the directional indication is validated.

10. The portable radio terminal according to claim 8, wherein:
the controller changes the display color of a part corresponding to a direction indicated by the directional indication in the figure of valid directions and instructs the display to display the changed figure when the directional indication is validated.

11. The portable radio terminal according to claim 8, wherein:
the controller changes the display form of a part corresponding to a direction indicated by the directional indication in the figure of valid directions and instructs the display to display the changed figure when the directional indication is validated.

12. The portable radio terminal according to claim 8, wherein:
the display displays a screen that is provided with plural areas for displaying items showing the contents of operation and the contents of processing and the figure of valid directions; and
the controller instructs the display to display the figure of valid directions showing all directions indicated by the directional indication and validated on the following switched screen when the screen displayed on the display is switched to another screen.

13. A method of setting an indicatable direction of a preset direction indicator key in a portable radio terminal, comprising:
a first step for specifying a direction in which directional indication output by the direction indicator key is validated; and
a second step for setting the valid direction specified in the first step.

14. The method according to claim 13, wherein:
for the valid direction, there are two types of eight longitudinal, lateral and diagonal directions and four longitudinal and lateral directions.

15. The method according to claim 13, further comprising:
a step for displaying a figure designating all directions included in the currently set valid directions.

16. The method according to claim 15, further comprising:
a step for changing a part corresponding to a direction indicated by the direction indicator key in the figure designating directions and displaying the changed figure.

17. The method according to claim 15, further comprising:
a step for changing the display color of a part corresponding to a direction indicated by the direction indicator key in the figure designating directions and displaying the changed figure.

18. The method according to claim 15, further comprising:
a step for changing the display form of a part corresponding to a direction indicated by the direction indicator key in the figure designating directions and displaying the changed figure.

19. A method of setting an indicatable direction of a preset direction indicator key in a portable radio terminal, wherein:
a valid direction showing a direction in which directional indication according to the following switched screen output by the direction indicator key is judged valid when the currently displayed screen is switched to another screen is set.
